(19) United States
(12) Patent Application Publication
(10) Pub. No.: US 2012/0079180 A1
(43) Pub. Date: Mar. 29, 2012

(54) DRAM Controller and a method for command controlling

(76) Inventor: Kai Ren, Hangzhou (CN)

(21) Appl. No.: 13/242,554

(22) Filed: Sep. 23, 2011

(30) Foreign Application Priority Data
Sep. 25, 2010 (CN) 201010291555.8

(51) Int. Cl. G06F 12/00

(52) U.S. Cl. 711/105; 711/E12.001

(57) ABSTRACT

A memory controller and a command control method are disclosed. When there is a need to access an unactivated bank in an external DRAM, an ACT command and an access command of a low rate are generated in parallel for the bank, and the parallel ACT and access commands of the low rate are sequentially output to a bus of the external DRAM in serial at a high rate.

### BACKGROUND

CPU and I/O devices need to access data in an external memory system through a memory controller in a computer system. The external memory system connected to the memory controller is implemented by, for example, a Dynamic Random Access Memory (DRAM) device, including a Double Data Rate 2 Synchronous Dynamic Random Access Memory (DDR2 SDRAM) device and a Double Data Rate 3 Synchronous Dynamic Random Access Memory (DDR3 SDRAM) device. Thus the external memory system can also be called an external DRAM system.

### BRIEF DESCRIPTION OF THE DRAWINGS

FIG. 1 is a schematic diagram of an example of a computer system comprising a memory controller.

FIG. 2a is a timing diagram of a read command consecutively accessing different rows of a bank on a DRAM bus in an example of a computer system comprising a memory controller.

FIG. 2b is a timing diagram of a read command consecutively accessing different rows of different banks on a DRAM bus in an example of a computer system comprising a memory controller.

FIG. 3 is a schematic diagram of an example of a computer system performing command dispatching.

FIG. 4 is a schematic diagram of an example of a half-rate memory controller.

FIG. 5 is a schematic diagram of an example of a state machine of the half-rate memory controller shown in FIG. 4.

FIG. 6 is a schematic diagram of an example of internal timing of the half-rate memory controller shown in FIG. 4 and the corresponding timing on the DRAM bus.

FIG. 7 is a schematic diagram of an example of a single-rate memory controller.

FIG. 8 is a schematic diagram of an example of internal timing of the single-rate memory controller shown in FIG. 7 and the corresponding timing on the DRAM bus.

FIG. 9 is a schematic diagram of a state machine of a memory controller according to an example.

FIG. 10 is a schematic diagram of a memory controller according to an example.

FIG. 11 is a schematic diagram of internal timing of the memory controller according to the example and the corresponding timing on the DRAM bus.

FIG. 12 is a schematic diagram of a memory controller according to another example.

FIG. 13 is a schematic diagram of internal timing of the memory controller according to the other example and the corresponding timing on the DRAM bus.

FIG. 14 is a flow chart of a command control method for a memory controller according to an example.

### DETAILED DESCRIPTION

Examples are described in detail below with reference to the drawings.

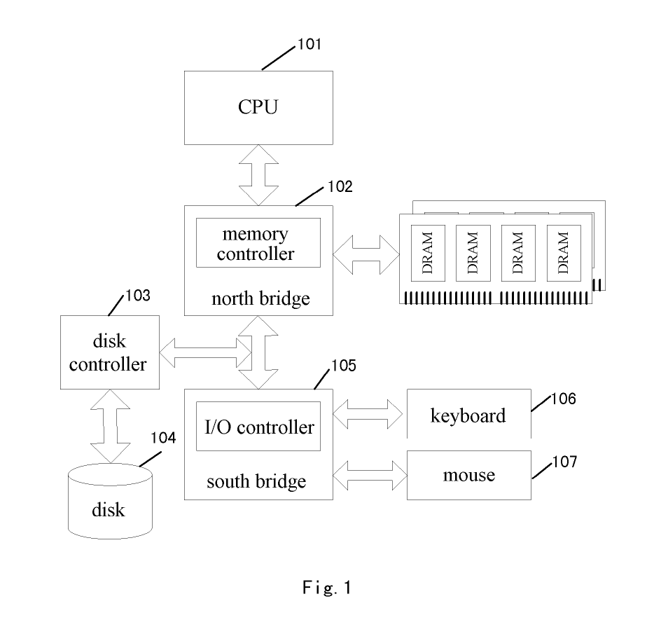

FIG. 1 shows a schematic diagram of an example of a computer system comprising a memory controller. CPU and I/O devices access data in an external memory system through a memory controller in a computer system.

The memory controller is used for reading data from a DRAM device (e.g. a DDR2 SDRAM or a DDR3 SDRAM, etc.) in a memory system and for writing data to the DRAM device in the memory system. During reading and writing of the data, the memory controller needs to make sure that a protocol for accessing the DRAM device is correct, and needs to meet requirements of interface electrical characteristics and timing characteristics of the DRAM device at the same time. Sometimes, it also needs to have an error detection and correction function.

The memory controller determines memory performance of the computer system, and hence has a great influence on overall performance of the computer system. Therefore, many of memory controllers are designed to have a high performance.

CPUs of many computer systems adopt a multi-thread and multi-core technique. Each thread and each CPU core can independently implement a certain application. For example, thread 0 transfers data from a hard disc to an external DRAM device, while thread 1 reads data from the external DRAM device. Hence multiple threads (or multiple CPU cores) simultaneously accessing the same external DRAM device through a memory controller will frequently occur. That is to say, the threads and CPU cores access the external DRAM device in an interleaving manner. Moreover, each thread (or CPU core) has a different function, so commands of access to the external DRAM device by threads (or CPU cores) will not be a consecutive address access. In this case, the memory controller that is designed to have a high performance needs to be optimized for a random address access.

The random access to an external DRAM device through a memory controller generally includes the following two cases.

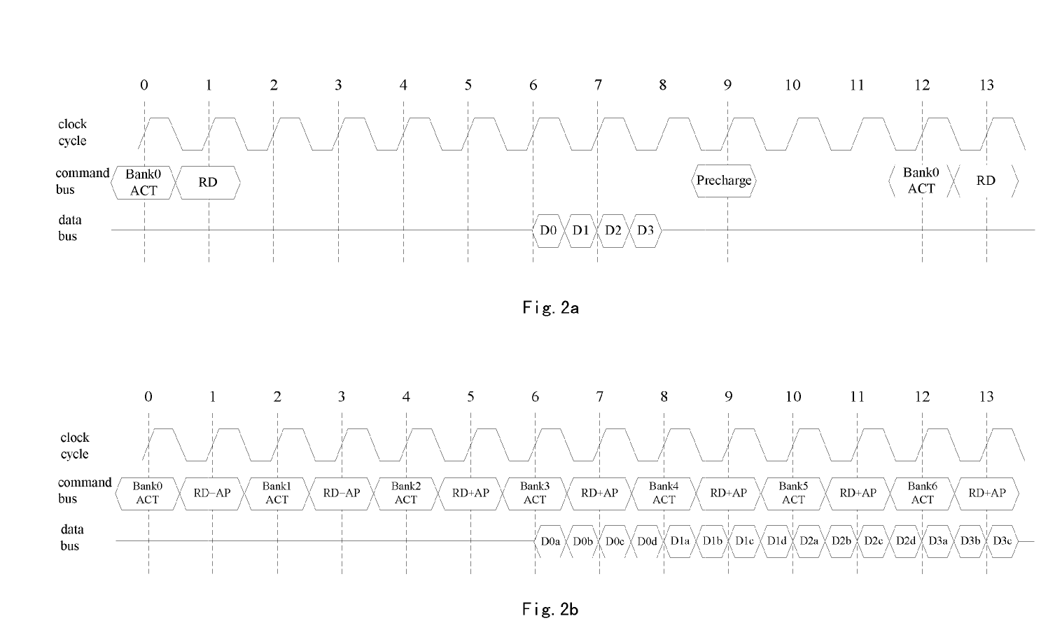

In a first case, a plurality of consecutive accesses occur in different rows of the same bank of the DRAM device. As shown in FIG. 2a, taking DDR2 SDRAM as an example, when rows in Bank0 are accessed consecutively, a corresponding row in Bank0 that needs to be subject to a read access is opened through an activation (ACT) command, and then a read (RD) command is sent. Upon completion of reading of data D0-D3 in the corresponding row of Bank0, the row is closed through a precharge (Precharge) command such that the ACT command is sent again to open a next row in Bank0 and the RD command is sent again. In FIG. 2a, there is an interval of 12 clock cycles between two RD commands, and data transmission corresponding to each RD command occupies only two clock cycles. Thus a DRAM bus efficiency is only 16.7% (2/12=16.7%) during the read access.

In a second case, a plurality of consecutive accesses occur in different rows of different banks of the DRAM device. Since each bank of the DRAM device is controlled by an independent corresponding circuit, the consecutive accesses to different banks will not be affected by inherent timing parameters of the DRAM device. As shown in FIG. 2b, taking DDR2 SDRAM as an example, when consecutively accessing different rows in Bank0, Bank1, Bank2, Bank3, Bank4, Bank5 and Bank6, an ACT command is generated for each bank at clock cycles 0, 2, 4, 6, 8, 10 and 12 successively, while a read with auto-precharge (RD+AP) command for the corresponding bank is generated at clock cycles 1, 3, 5, 7, 9, 11 and 13 successively. After a read delay period, read data D0a-D0d of Bank° appear in clock cycles 6 and 7, read data D1a-D1d of Bank1 appear in clock cycles 8 and 9, read data D2a-D2d of Bank2 appear in clock cycles 10 and 11, and so on. The read data of each bank are connected end to end, such that a DRAM bus starting from clock cycle 6 has no idle period, and thus the DRAM bus efficiency is 100% at this time.

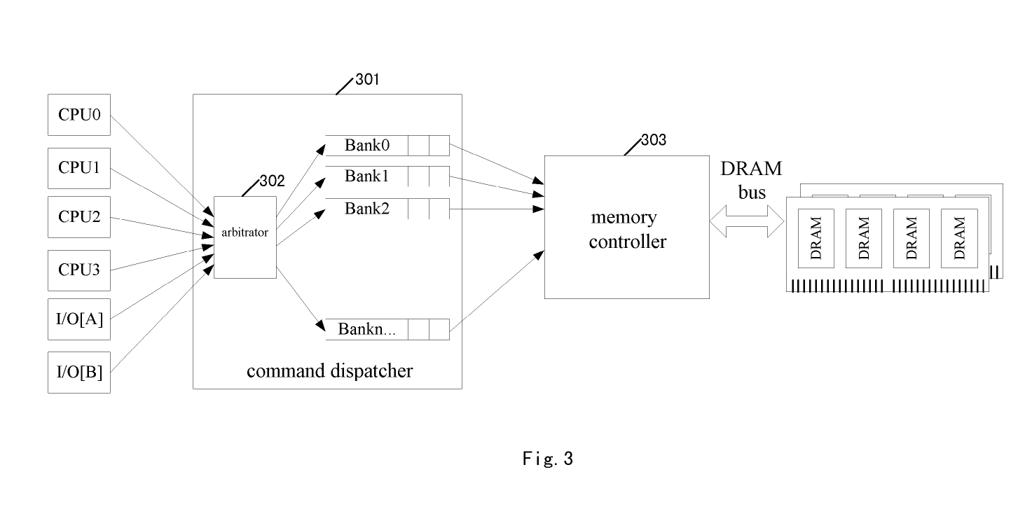

It can be seen that the DRAM bus efficiency in the second case is obviously higher than that in the first case. Therefore, to ensure a high DRAM bus efficiency, as shown in FIG. 3, a computer system have a command dispatcher 301 added in CPU/IO devices and a memory controller 303. An arbitrator 302 in the command dispatcher buffers into the corresponding queues the commands dispatching each of CPU threads (or CPU cores) and the commands of I/O devices for different banks. Then the memory controller polls and reads the commands in the queue corresponding to each bank, thus avoiding the above-mentioned first case and satisfying the above-mentioned second case.

However, even though the interleaving access to the banks as mentioned in the second case can be fulfilled by the command dispatcher, there are other problems resulted from operating frequencies, since the memory controller and the external DRAM device have their own operating frequencies.

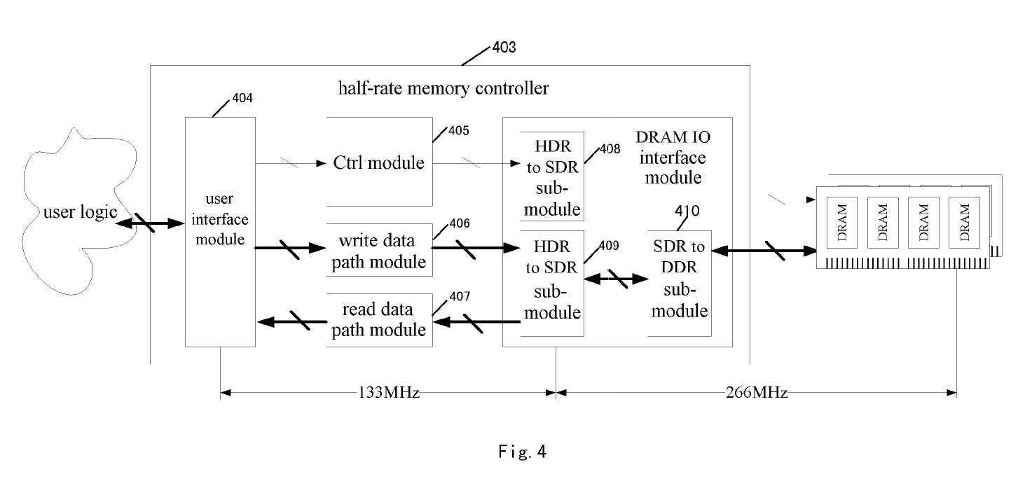

As shown in FIG. 4, taking DDR2 SDRAM as an example, an internal operating frequency of a memory controller 403 is 133 MHz, and a bus frequency of an external DDR2 SDRAM is 266 MHz. Hence the memory controller in FIG. 4 can be called a half-rate memory controller (the “half-rate”, “single-rate”, “double-rate”, etc. as used throughout this document are relative to a bus rate of the external DRAM). The half-rate memory controller comprises a control (Ctrl) module 405, a write data path module 406 and a read data path module 407 operating at 133 MHz. The half-rate memory controller further comprises a user interface module 404 that can interact with a user logic, and a DRAM IO interface module connecting to an external bus of the DDR2 SDRAM and implementing a conversion between the internal operating frequency and the external bus frequency.

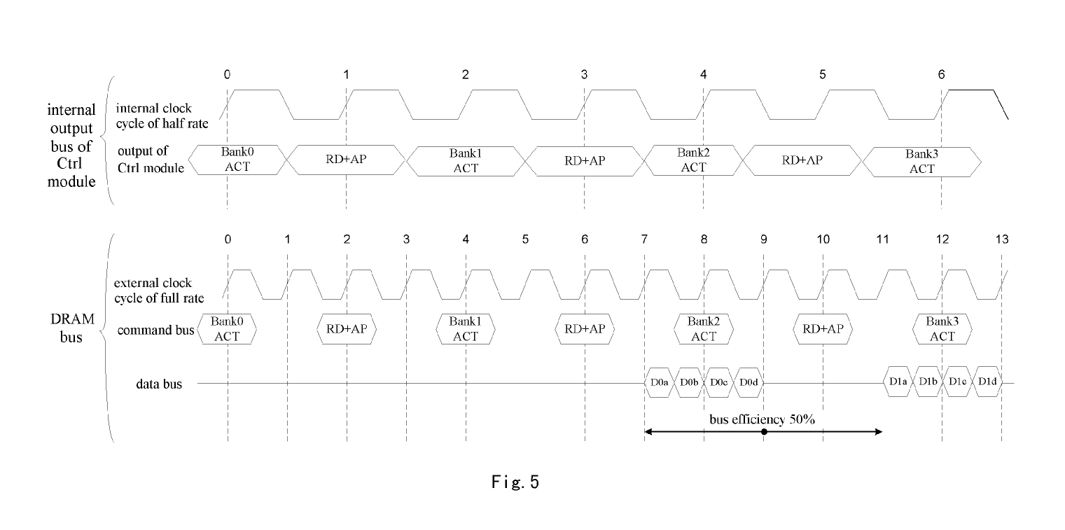

The Ctrl module is used for implementing all DRAM interface protocols, matching timing parameters of the DRAM interface, and generating various kinds of commands (CMD). Specifically, the Ctrl module can perform state transitions according to a state machine as shown in FIG. 5 in the light of instructions from the user logic, and generate a corresponding CMD when transitioning to a state. Only relevant states in the state machine shown in FIG. 5 are described below, while other states irrelevant to this document are not described.

The write data path module is used for buffering write data of the user logic and writing the write data into the DRAM IO interface module at a half rate. The read data path module is used for buffering half-rate read data read by the DRAM IO interface module from an external DRAM device and sending the read data to the user interface module.

The DRAM IO interface module comprises a half rate to single rate conversion (HDR to SDR) sub-module 408 for converting half-rate commands generated by the Ctrl module into single-rate commands to be output to the external DDR2 SDRAM bus.

The DRAM IO interface module also comprises another HDR to SDR sub-module 409 and a single rate to double rate conversion (SDR to DDR) sub-module 410. The other HDR to SDR sub-module is used for converting the half-rate write data of the write data path module into single-rate write data to be transmitted to the SDR to DDR sub-module, and for converting single-rate read data from the SDR to DDR sub-module into half-rate read data to be provided to the read data path module. The SDR to DDR sub-module is used for converting the single-rate write data into double-rate write data to be output to the external DDR2 SDRAM bus, and for converting double-rate read data of the external DDR2 SDRAM bus into single-rate read data to be transmitted to the other HDR to SDR sub-module.

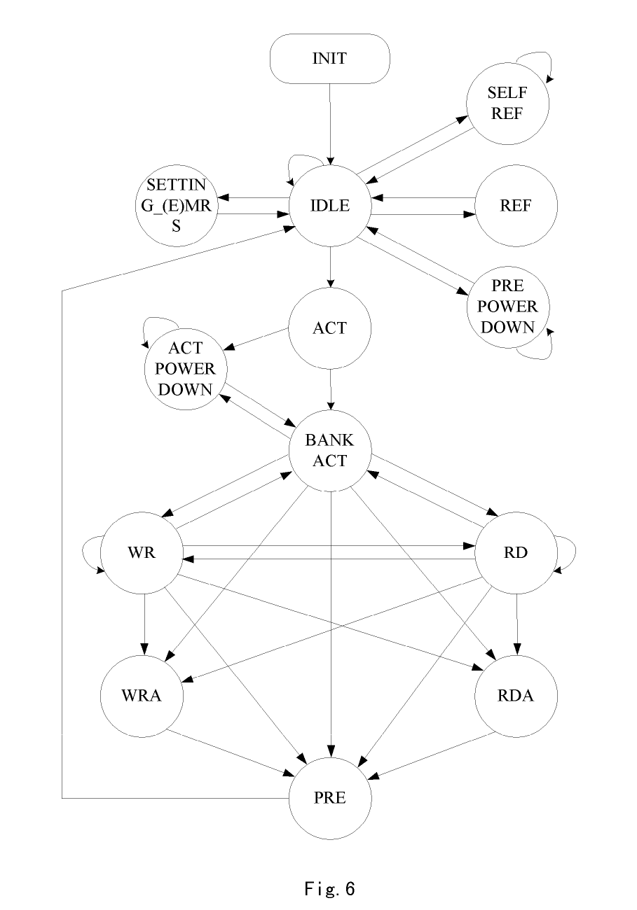

Referring to FIG. 6 in conjunction with FIGS. 4 and 5, when read accessing Bank0, Bank1, Bank2 and Bank3 in an interleaving manner, states of the state machine of the Ctrl module in cycle 0 to cycle 7 transition in the following cycle for Bank0, Bank1, Bank2 and Bank3: idle state (IDLE)→state active state (ACTIVE)→bank active state (BANK ACTIVE)→read with autoprecharge state (RDA)→precharge state (PRE)→IDLE. Thus the Ctrl module can alternately generate ACT commands and RD+AP commands for different banks. Accordingly, a command bus at DDR2 SDRAM also alternately outputs ACT commands and RD+AP commands for different banks.

Since an operating frequency of the Ctrl module in the half-rate memory controller is a half of the bus frequency of the external DDR2 SDRAM, half-rate ACT commands and half-rate RD+AP commands alternately generated by the Ctrl module are converted into alternate single-rate ACT commands and single-rate RD+AP commands on the command bus of the DDR2 SDRAM, and hence on the command bus of the external DDR2 SDRAM, every two adjacent single-rate ACT command and single-rate RD+AP command have an interval of one cycle therebetween. Thus on a data bus of the external DDR2 SDRAM, read data of every two banks have an interval of four cycles therebetween. As a result, a bus efficiency of the external DDR2 SDRAM is only 50% and cannot reach 100% as shown in FIG. 2b.

Likewise, when consecutively write accessing different rows in Bank0, Bank1, Bank2 and Bank3, state transitions of the Ctrl module for a write access to each bank can be IDLE→ACTIVE→BANK ACTIVE→write with autoprecharge state (WRA)→PRE→IDLE, and half-rate ACT commands and half-rate write with autoprecharge (WR+AP) commands are generated alternately. Therefore, the bus efficiency cannot reach 100% as shown in FIG. 2b, either.

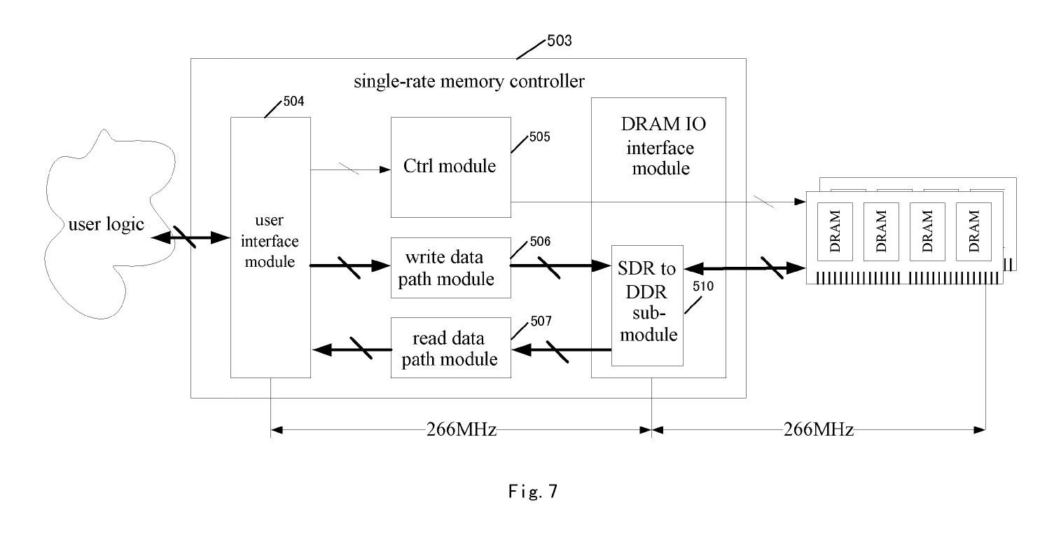

A single-rate memory controller is proposed. FIG. 7 shows a schematic diagram of an example of the single-rate memory controller.

As shown in FIG. 7, taking DDR2 SDRAM as an example, an internal operating frequency of a memory controller 503 and a bus frequency of an external DDR2 SDRAM are both 266 MHz. Hence the memory controller in FIG. 7 can be called a single-rate memory controller. The single-rate memory controller still comprises a Ctrl module 505 (based on the state machine shown in FIG. 5), a write data path module 506, a read data path module 507 and a user logic having the same principle as the half-rate memory controller, but a DRAM IO interface module of the full-rate memory controller is somewhat improved. Specifically, the DRAM IO interface module has only one SDR to DDR sub-module 510 for converting single-rate write data of the write data path module to be output to the external DDR2 SDRAM bus, and for converting read data of the external DDR2 SDRAM bus into single-rate read data to be directly transmitted to the read data path module. In addition, single-rate commands generated by the Ctrl module can be directly output to the external DDR2 SDRAM bus.

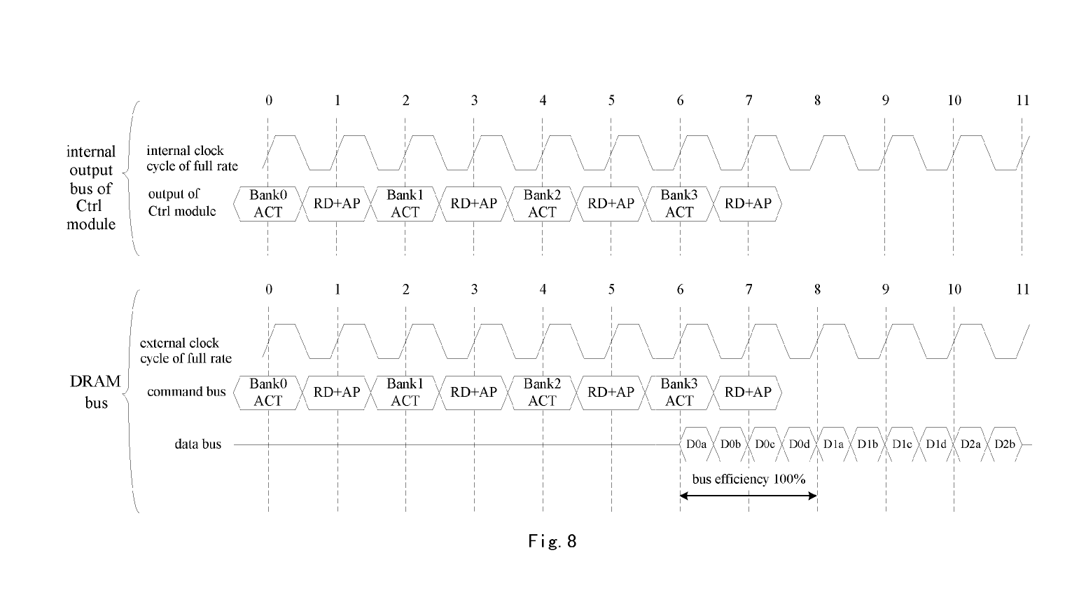

Referring to FIG. 8 in conjunction with FIG. 7, when read accessing Bank0, Bank1, Bank2 and Bank3 in an interleaving manner, the Ctrl module alternately generates ACT commands and RD+AP commands for different banks from cycle 0 to cycle 7. Accordingly, a command bus at DDR2 SDRAM also alternately outputs ACT commands and RD+AP commands for different banks.

Since an operating frequency of the Ctrl module in the single-rate memory controller is the same as a bus frequency of the external DDR2 SDRAM, there is no interval between every two adjacent single-rate ACT command and single-rate RD+AP command on a command bus of the external DDR2 SDRAM. As a result, there is an interval of four cycles between read data for every two banks on a data bus of the external DDR2 SDRAM, ensuring that a bus efficiency of the external DDR2 SDRAM can reach 100% as shown in FIG. 2b.

In various examples below, firstly an internal operating frequency of a memory controller is made to be lower than a bus frequency of an external DRAM so as to avoid implementation difficulty and problems in power supply and heat dissipation due to a too high internal operating frequency of the memory controller. Secondly, a Ctrl module can generate an ACT command of a low rate and any access command of a low rate such as RD, RD+AP, WR or WR+AP in parallel for a certain bank, and a DRAM IO interface module converts the two parallel commands of the low rate generated by the Ctrl module into two serial high rate commands that comply with the bus frequency of the external DRAM, thereby improving a bus efficiency of the external DRAM to ensure the performance during interleaving access to banks.

Specifically, in order to enable the Ctrl module to generate the ACT command of the low rate and any access command of the low rate in parallel for any bank, the examples improves a state machine of the Ctrl module.

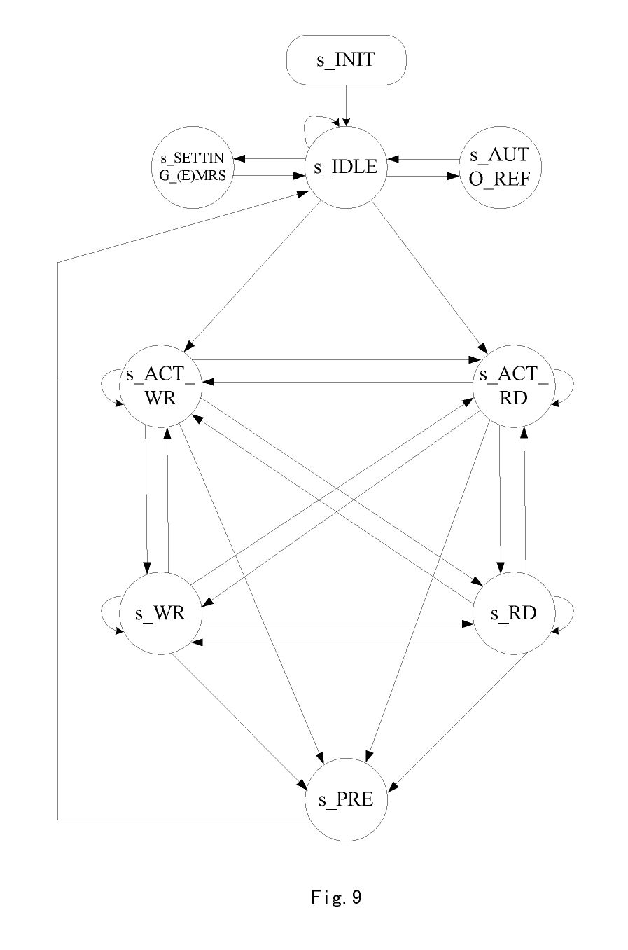

Specifically referring to FIG. 9, the state machine includes the following states (to be differentiated from states in the state machine shown in FIG. 6, an “s_” is added before each of the states of the state machine shown in FIG. 9):
an initialization state (s_INIT), which may have the same function as the INIT in the state machine shown in FIG. 6;
an idle state (s_IDLE), which may have the same function as the IDLE in the state machine shown in FIG. 6, and all banks in this state have been precharged;
a mode register setting state (s_SETTING_(E)MR), which may have the same function as the SETTING_(E)MR in the state machine shown in FIG. 6 and is used for configuring various mode registers;
an automatic refreshing state (s_AUTO_REF), which may have the same function as the REF in the state machine shown in FIG. 6;
an activation write state (s_ACT_WR) and an activation read state (s_ACT_RD), which are different from any state of the state machine shown in FIG. 6. When the user logic sends an ACT+WR/WRA command for an unactivated bank, the Ctrl module may transition from s_IDLE or s_ACT_RD to s_ACT_WR using this as a transition condition, and generate a low-rate ACT command and a low rate WR/WR+AP command in parallel for the unactivated bank in s_ACT_WR. When the user logic sends an ACT+RD/RDA command for an unactivated bank, the Ctrl module may transition from s_IDLE or s_ACT_WR to s_ACT_RD using this as a transition condition, and generate a low-rate ACT command and a low-rate RD/RD+AP command in parallel for the unactivated bank in s_ACT_RD;
a write state (s_WR) and a read state (s_RD), which have functions equivalent to a combination of WR and WRA and a combination of RD and RDA in the state machine shown in FIG. 6, but a state transition process thereof is different from that in the state machine shown in FIG. 6. When a certain bank has been activated under s_ACT_WR/s_ACT_RD, the user logic can send a WR/WRA command without a need of sending the ACT command again. At this time, the Ctrl module may use the WR/WRA command as a transition condition to transition from s_ACT_WR/s_ACT_RD/s_RD to s_WR, and generate a WR/WR+AP command of a low rate for the bank in s_WR so as to continue the write access to the activated bank. When a certain bank has been activated under s_ACT_WR/s_ACT_RD, the user logic may also send a RD/RDA command without a need of sending the ACT command again. At this time, the Ctrl module may use the RD/RDA command as a transition condition to transition from s_ACT_WR/s_WR/s_ACT_RD to s_RD, and generate a RD/RD+AP command of a low rate for the bank in s_RD so as to continue the read access to the activated bank; and
a precharge state (s_PRE), which may have the same function as the PRE in the state machine shown in FIG. 6 and is used for pre-charging a bank that has completed the read/write access. The Ctrl module may transition from s_ACT_WR/s_WR/s_ACT_RD/s_RD to s_PRE after completion of the access, and transition back to s_IDLE after completion of the precharging.

It can be seen from the above that a difference between the state machine shown in FIG. 9 and the state machine shown in FIG. 6 is adding the s_ACT_WR and the s_ACT_RD for generating low-rate commands in parallel. Besides, the transition conditions for s_WR and s_RD in the state machine shown in FIG. 9 is different from the WR/WRA and RD/RDA shown in FIG. 6. This is to adapt to the access after activation of s_ACT_WR and s_ACT_RD.

In addition, since functions of the states like activation power down state (ACT Power Down), self-refreshing state (SELF REF) and precharge power down state (PRE Power Down) shown in FIG. 6 are relatively independent and are not closely related to the example, these states are omitted in the state machine shown in FIG. 9.

The detailed description will be given below for different DRAM devices.

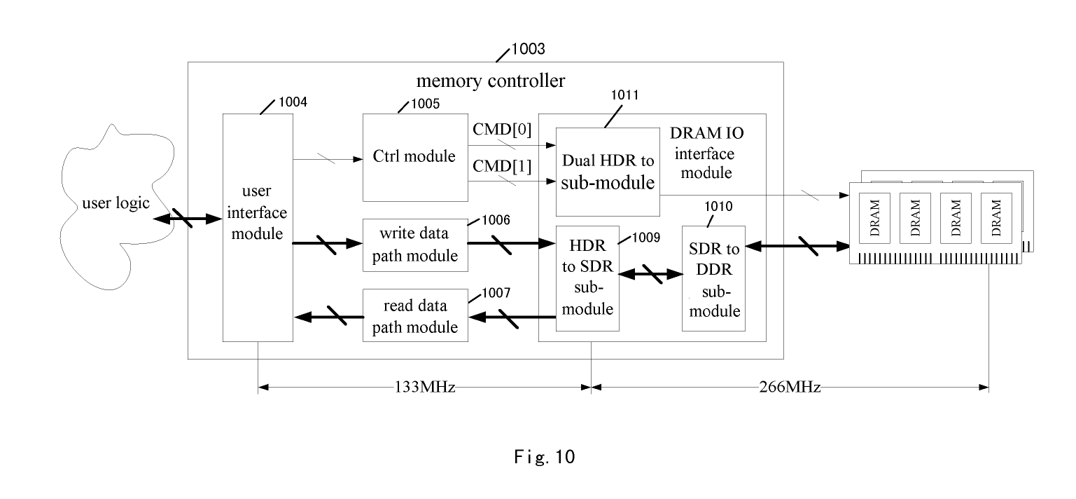

As shown in FIG. 10, a memory controller 1003 for DDR2 SDRAM in an example comprises a Ctrl module 1005, a write data path module 1006 and a read data path module 1007 operating at an internal operating frequency of 133 MHz. The memory controller further comprises a user interface module 1004 that can interact with a user logic, and a DRAM IO interface module connecting to an external bus of DDR2 SDRAM and implementing a conversion between the internal operating frequency and the external bus frequency.

The Ctrl module is used for implementing all DRAM interface protocols, matching timing parameters of the DRAM interface, and generating various kinds of CMDs. The Ctrl module has dual output commands CMD[0] and CMD[1]. The Ctrl module can perform state transitions according to the state machine as shown in FIG. 9 in the light of instructions from the user logic and generate, at CMD[0] and CMD[1], two half-rate ACT commands and RD/RD+AP/WR/WR+AP in parallel corresponding 133 MHz when transitioning to s_ACT_WR/s_ACT_RD.

Specifically, the Ctrl module can directly transition from s_IDLE/s_ACT_RD to s_ACT_WR for any unactivated bank, and output an ACT command and a WR/WR+AP command at the same time in s_ACT_WR, without a need to generate the ACT command through the BANK ACT state first and then reach the WR/WRA state as in the state machine shown in FIG. 6.

The Ctrl module can directly transition from s_IDLE/s_ACT_WR to s_ACT_RD for any unactivated bank, and output an ACT command and a WR/WR+AP command at the same time in s_ACT_RD, without a need to generate the ACT command through the BANK ACT state first and then reach the RD/RDA state as in the state machine shown in FIG. 6.

The Ctrl module can directly transition from s_ACT_RD/s_ACT_WR/s_RD to s_WR for any activated bank, and output only a WR/WR+AP command in s_WR.

The Ctrl module can directly transition from s_ACT_RD/s_ACT_WR/s_WR to s_RD for any activated bank, and output only an RD/RD+AP command in s_RD.

The DRAM IO interface has a dual half rate to single rate conversion (Dual HDR to SDR) sub-module 1011 for converting the two half-rate commands CMD[0] and CMD[1] generated by the Ctrl module into two consecutive serial single rate command. Specifically, the Dual HDR to SDR sub-module sequentially outputs the parallel ACT command and WR/WR+AP/RD/RD+AP command of a half rate generated by the Ctrl module to the external DDR2 SDRAM bus in serial at a single rate corresponding to a bus frequency 266 MHz of the external DDR2 SDRAM.

The write data path module is used for buffering write data to be written into the external DRAM by the user logic and for writing the write data to be written into the external DRAM into the DRAM IO interface module at the half rate.

The read data path module is used for receiving half-rate read data from the DRAM IO interface module and buffering it so as to be obtained by the user logic.

In addition, the DRAM IO interface module also comprises an HDR to SDR sub-module 1009 and an SDR to DDR sub-module 1010.

The HDR to SDR sub-module is used for converting half-rate write data of the write data path module into single-rate write data to be transmitted to the SDR to DDR sub-module, and for converting single-rate read data from the SDR to DDR sub-module into half-rate read data to be provided to the read data path module.

The SDR to DDR sub-module is used for converting single-rate write data into double-rate to be output to the external DDR2 SDRAM bus, and for converting double-rate read data of the external DDR2 SDRAM bus into single-rate read data to be transmitted to another HDR to SDR sub-module.

The write data path module, the read data path module, the HDR to SDR sub-module and the SDR to DDR sub-module FIG. 10 are substantially the same as those in FIG. 4, and they will not be detailed herein.

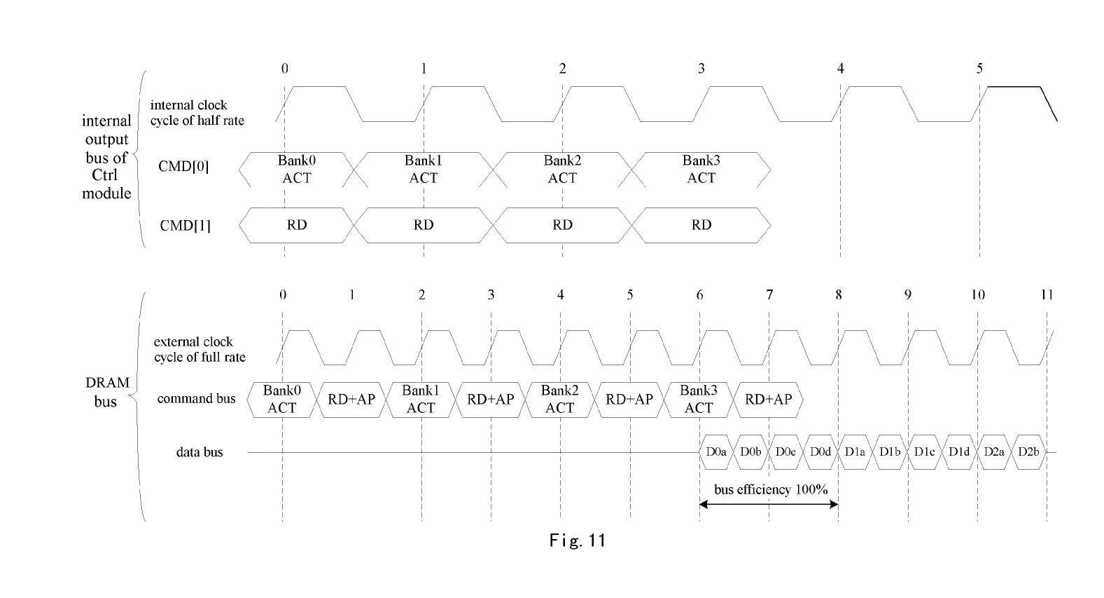

Referring to FIG. 11 in conjunction with FIG. 10, when performing an interleaving read access to Bank0, Bank1, Bank2 and Bank3, all of Bank0, Bank1, Bank2 and Bank3 are unactivated banks. When the Ctrl module is at cycle 0 to cycle 3 of its internal operating frequency, a state transition sequence of the internal state machine thereof is s_ACT_RD→s_ACT_RD→s_ACT_RD→s_ACT_RD, and in each clock cycle, an ACT command is sent on CMD[0] and an RD command is sent on CMD[1].

After the command output from the Ctrl module passes through the Dual HDR to SDR sub-module, the ACT command on CMD[0] is converted into a command of a previous cycle of the external DDR2 SDRAM bus, and the RD command on CMD[1] is converted into a command of a next cycle of the external DDR2 SDRAM bus. Thus on a command bus of the external DDR2 SDRAM, the ACT command→RD command→ACT command→RD command . . . are output successively at the clock cycle 0 to clock cycle 7 of its external bus frequency.

After a read delay period, on a data bus of the external DDR2 SDRAM, read data D0a-D0d of Bank0 appear in clock cycles 6 and 7 of the external bus frequency, read data D1a-D1d of Bank1 appear in clock cycles 8 and 9, and so on. Read data of every two banks are connected end to end, and there is no idle clock cycle. Hence a bus efficiency of the external DDR2 SDRAM is 100%.

When carrying out this example in reality, a posted CAS additive latency (AL) parameter of memory chips of the DDR2 SDRAM has to be configured to be equal to a difference between a minimum value of an act->read/write delay (tRCD) parameter and one time a unit clock cycle tCK of the external DDR2 SDRAM bus. Specifically, it may be expressed by a function AL=tRCD (MIN)−1×tCK, thereby ensuring that the ACT command is immediately followed by the WR/WR+AP/RD/RD+AP command.

Another example is described below in detail in which DDR3 SDRAM is used.

DDR3 SDRAM and DDR2 SDRAM have substantially the same internal structure and interface protocol. Hence a memory controller for DDR3 SDRAM in this example is basically implemented in the same way as the memory controller for DDR2 SDRAM in the above example.

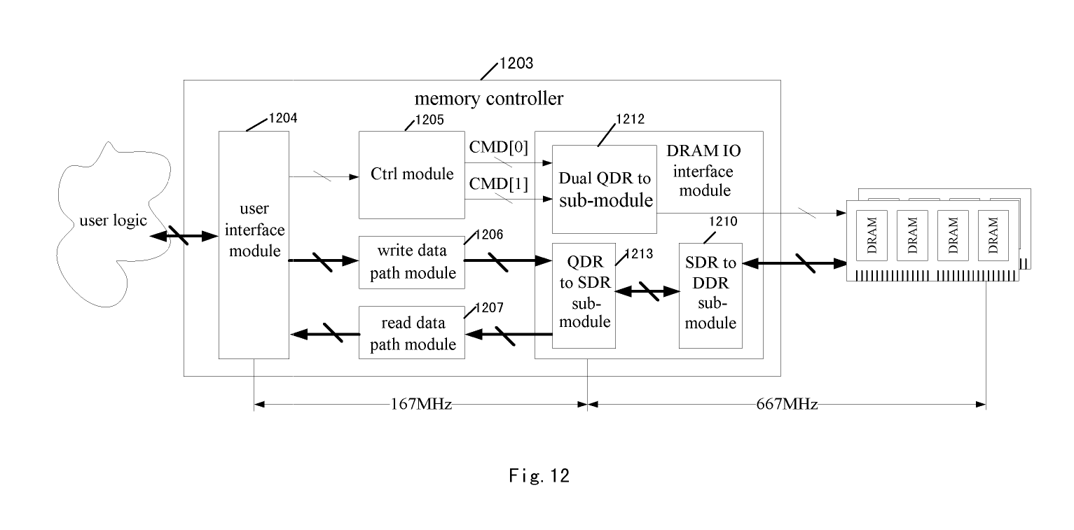

As shown in FIG. 12, a memory controller 1203 for DDR3 SDRAM in this example comprises a Ctrl module 1205, a write data path module 1206 and a read data path module 1207 operating at an internal operating frequency of 167 MHz. The memory controller also comprises a user interface module 1204 that can interact with a user logic, and a DRAM IO interface module connecting to an external bus of DDR3 SDRAM and implementing a conversion between the internal operating frequency and the external bus frequency.

The Ctrl module is used for implementing all DRAM interface protocols, matching timing parameters of the DRAM interface, and generating various kinds of CMDs. The Ctrl module has dual output commands CMD[0] and CMD[1]. The Ctrl module can perform state transitions according to the state machine shown in FIG. 9 in the light of instructions from the user logic and generate, at CMD[0] and CMD[1], two quarter-rate ACT commands and RD/RD+AP/WR/WR+AP in parallel corresponding 133 MHz when transitioning to s_ACT_WR/s_ACT_RD.

Specifically, the Ctrl module can directly transition from s_IDLE/s_ACT_RD to s_ACT_WR for any unactivated bank, and output an ACT command and a WR/WR+AP command at the same time in s_ACT_WR, without a need to generate the ACT command through the BANK ACT state first and then reach the WR/WRA state as in the state machine shown in FIG. 6.

The Ctrl module can directly transition from s_IDLE/s_ACT_WR to s_ACT_RD for any unactivated bank, and output an ACT command and a WR/WR+AP command at the same time in s_ACT_RD, without a need to generate the ACT command through the BANK ACT state first and then reach the RD/RDA state as in the state machine shown in FIG. 6.

The Ctrl module can directly transition from s_ACT_RD/s_ACT_WR/s_RD to s_WR for any activated bank, and output only a WR/WR+AP command in s_WR.

The Ctrl module can directly transition from s_ACT_RD/s_ACT_WR/s_WR to s_RD for any activated bank, and output only a RD/RD+AP command in s_RD.

The DRAM IO interface has a dual quarter rate to single rate conversion (Dual QDR to SDR) sub-module 1212 for converting the two quarter rate commands CMD[0] and CMD[1] generated by the Ctrl module into consecutive “CMD[0]→NOP→CMD[1]→NOP”. Namely, a null command is inserted between two serial single-rate commands and after a next single-rate command. Specifically, the Dual QDR to SDR sub-module sequentially outputs the parallel ACT command and the WR/WR+AP/RD/RD+AP command of the quarter rate generated by the Ctrl module to the external DDR3 SDRAM bus in serial at a single rate corresponding to a bus frequency 667 MHz of the external DDR3 SDRAM.

The write data path module is used for buffering write data to be written into the external DRAM by the user logic and for writing the write data to be written into the external DRAM into the DRAM IO interface module at the quarter rate.

The read data path module is used for receiving the quarter-rate read data from the DRAM IO interface module and buffering it so as to be obtained by the user logic.

In addition, the DRAM IO interface module also comprises a quarter rate to single rate conversion (QDR to SDR) sub-module 1213 and an SDR to DDR sub-module 1210.

The QDR to SDR sub-module is used for converting the quarter-rate write data of the write data path module into single-rate write data to be transmitted to the SDR to DDR sub-module, and for converting single-rate read data from the SDR to DDR sub-module into quarter-rate read data to be provided to the read data path module.

The SDR to DDR sub-module is used for converting single-rate write data into double-rate write data so as to be output to the external DDR3 SDRAM bus, and for converting double-rate read data of the external DDR3 SDRAM bus into single-rate read data to be transmitted to another HDR to SDR sub-module.

The write data path module, the read data path module, the HDR to SDR sub-module and the SDR to DDR sub-module in FIG. 12 are substantially the same as those in FIG. 4, and they will not be elaborated herein.

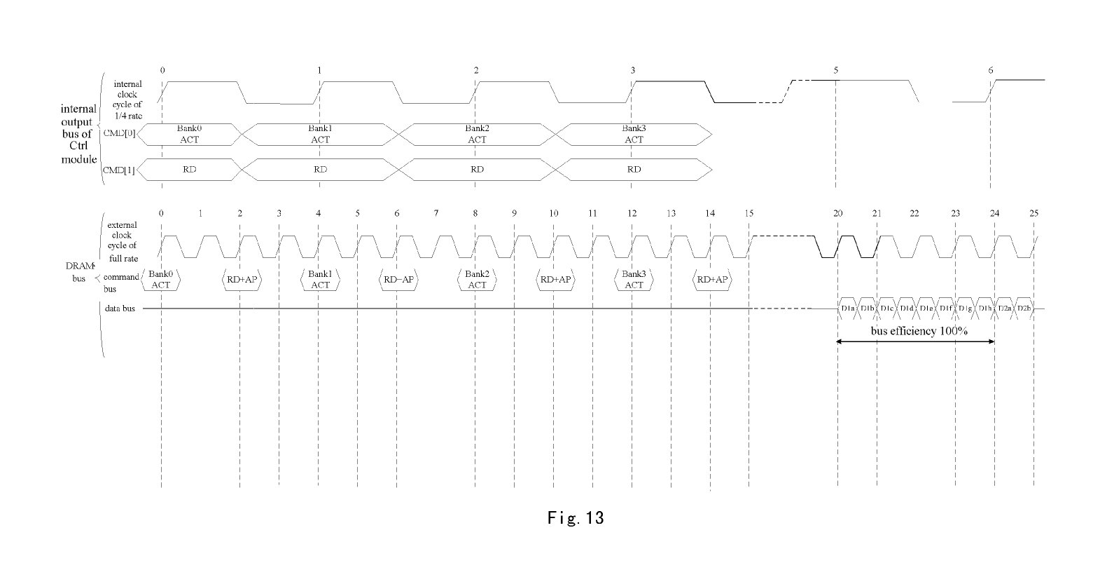

Referring to FIG. 13 in conjunction with FIG. 12, when performing an interleaving read access to Bank0, Bank1, Bank2 and Bank3, all of Bank0, Bank1, Bank2 and Bank3 are unactivated banks. When the Ctrl module is at cycle 0 to cycle 3 of its internal operating frequency, a state transition sequence of the internal state machine thereof is s_ACT_RD→s_ACT_RD→s_ACT_RD→s_ACT_RD, and in each clock cycle, an ACT command is sent on CMD[0] and an RD command is sent on CMD[1].

After the command output from the Ctrl module passes through the Dual QDR to SDR sub-module, the ACT command on CMD[0] is converted into a command of a previous cycle of the external DDR3 SDRAM bus, and the RD command on CMD[1] is converted into a command of a next cycle of the external DDR3 SDRAM bus, and there is a null command NOP between the command of the previous cycle and the command of the next cycle. Thus on a command bus of the external DDR3 SDRAM, the ACT command→RD command→ACT command→RD command . . . are output successively at the clock cycle 0 to clock cycle 15 of its external bus frequency.

After a read delay period, on a data bus of the external DDR3 SDRAM, read data D0a-D0d of Bank0 appear in clock cycles 20-23 of the external bus frequency, read data D1a-D1d of Bank1 appear starting from clock cycle 24, and so on. Read data of every two banks are connected end to end, and there is no idle clock cycle. Hence a bus efficiency of the external DDR3 SDRAM is 100%.

When carrying out this example in reality, the AL parameter of memory chips of the DDR3 SDRAM has to be configured to be equal to a difference between a minimum value of a tRCD parameter and two times a unit clock cycle tCK of the external DDR3 SDRAM bus. Specifically, it may be expressed by a function AL=tRCD (MIN)−2×tCK, thereby ensuring that the ACT command is immediately followed by the WR/WR+AP/RD/RD+AP command.

The operating frequency of the Ctrl module of the memory controller for DDR3 SDRAM in this example is a quarter of the bus frequency of the external DDR3 SDRAM. Therefore, when the external bus frequency of DDR3 SDRAM is at the highest 800 MHz, the operating frequency of the Ctrl module can be only 200 MHz, thus enabling the memory controller easily to implement.

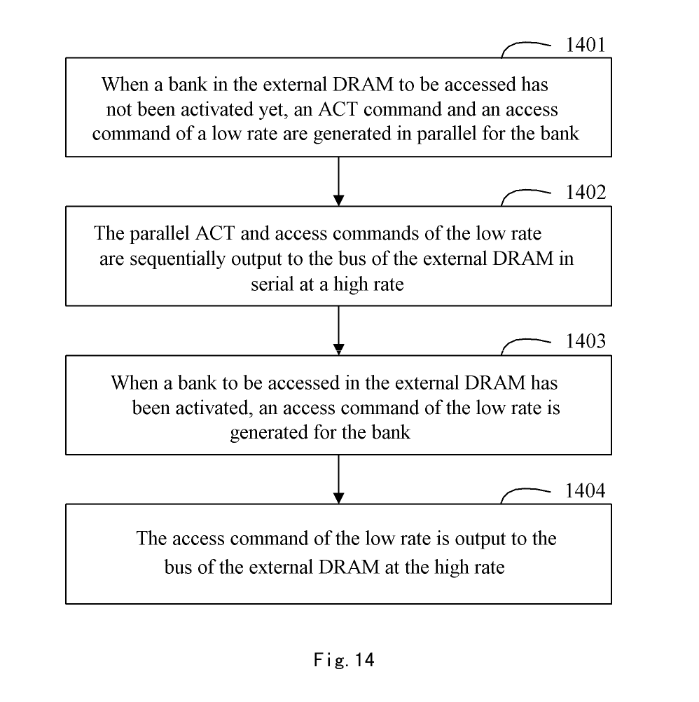

Based on the basic principles of the memory controllers of the above two examples, an example of a command control method for the memory controller is provided, as shown in FIG. 14. The command control method can perform the following for any bank of the external DRAM:

Block 1401, when a bank in the external DRAM to be accessed has not been activated yet, an ACT command and an access command of a low rate are generated in parallel for the bank. The low-rate commands correspond to the internal operating frequency of the memory controller.

During a read access, an access command in this block is an RD command or an RD+AP command. During a write access, an access command in this block is a WR command or a WR+AP command.

Block 1402, the parallel ACT and access commands of the low rate are sequentially output to the bus of the external DRAM in serial at a high rate. The high rate corresponds to the bus frequency of the external DRAM device.

If the external DRAM is a DDR2 SDRAM, the low rate is a half of the high rate. If the external DRAM is a DDR3 SDRAM, the low rate is a quarter of the high rate. Then in this block, a null command will have to be inserted between the ACT command and the access command that are sequentially output in serial at the high rate and after the access command.

Block 1403, when a bank to be accessed in the external DRAM has been activated, an access command of a low rate is generated for the bank.

Block 1404, the access command of the low rate is output to the bus of the external DRAM at the high rate.

So far, the processing of one bank is completed.

Upon completion of the processing of the one bank, transmission of read/write data can be performed to the one bank with reference to the basic principle of the memory controller.

All of the features disclosed in this specification (including any accompanying claims, abstract and drawings), and/or all of the processes or blocks of any method so disclosed, may be combined in any combination, except combinations where at least some of such features and/or processes or blocks are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A memory controller comprising:
a control module, which, when there is a need to access an unactivated bank in an external DRAM, generates an activation command and an access command of a first rate in parallel for the bank;
a DRAM IO interface module, which sequentially outputs the parallel activation and access commands of the first rate to a bus of the external DRAM in serial at a second rate; wherein the first rate corresponding to an operating frequency of the control module is lower than the second rate corresponding to a bus frequency of the external DRAM;
a write data path module, which writes write data to be written into the external DRAM into the DRAM IO interface module at the first rate, the write data being output to the bus of the external DRAM after having been converted to a double second rate by the DRAM IO interface module; and
a read data path module, which receives read data of the first rate from the DRAM IO interface module, the read data of the first rate being obtained by converting the double second rate read data read from the bus of the external DRAM by the DRAM IO interface module.

2. The memory controller of claim 1, wherein when there is a need to access an activated bank in the external DRAM, the control module further generates an access command of the first rate for the bank;
the DRAM IO interface module further outputs the access command of the first rate to the bus of the external DRAM at the second rate.

3. The memory controller of claim 1, wherein when the access is a read access, the access command is a read command or a read autoprecharge command;
when the access is a write access, the access command is a write command or a write autoprecharge command.

4. The memory controller of claim 1, wherein the external DRAM is a DDR2 SDRAM, and the first rate is a half of the second rate.

5. The memory controller of claim 1, wherein the external DRAM is a DDR3 SDRAM, and the first rate is a quarter of the second rate, and
a null command is inserted between the activation command and the access command that are sequentially output in serial at the second rate and after the access command.

6. A command control method for a memory controller, the command control method comprising:
when there is a need to access an unactivated bank in an external DRAM, generating an activation command and an access command of a first rate in parallel for the bank; and
sequentially outputting the parallel activation and access commands of the first rate to a bus of the external DRAM in serial at a second rate;
wherein, the first rate corresponding to an operating frequency of a control module is lower than the second rate corresponding to a bus frequency of the external DRAM.

7. The command control method of claim 6, wherein when there is a need to access an activated bank in the external DRAM, the method further generates an access command of the first rate for the bank, and further outputs the access command of the first rate to the bus of the external DRAM at the second rate.

8. The memory controller method of claim 6, wherein
when the access is a read access, the access command is a read command or a read autoprecharge command; and
when the access is a write access, the access command is a write command or a write autoprecharge command.

9. The command control method of claim 6, wherein the external DRAM is a DDR2 SDRAM, and the first rate is a half of the second rate.

10. The command control method of claim 6, wherein the external DRAM is a DDR3 SDRAM, and the first rate is a quarter of the second rate, and
a null command is inserted between the ACT command and the access command that are sequentially output in serial at the second rate and after the access command.
